(19) United States
(12) Patent Application Publication
(10) Pub. No.: US 2020/0302768 A1
(43) Pub. Date: Sep. 24, 2020

(54) LOCATING DEVICE

(71) Applicant: Eaton Intelligent Power Limited, Dublin (IE)

(72) Inventors: Stewart Parfitt, Hertfordshire (GB); Peter Rigling, Herts (GB); Christopher W. Kelson, Fayetteville, NY (US); James Cooke, Pwllheli (GB); Joseph Michael Manahan, Manlius, NY (US)

(73) Assignee: Eaton Intelligent Power Limited, Dublin (IE)

(21) Appl. No.: 16/814,469

(22) Filed: Mar. 10, 2020

Related U.S. Application Data
(60) Provisional application No. 62/822,511, filed on Mar. 22, 2019.

(51) Int. Cl. G08B 21/02; G08B 5/22; G08B 25/10

(52) U.S. Cl. CPC G08B 21/02; G08B 25/10; G08B 5/22

(57) ABSTRACT

An electronic user-location device comprises an input module configured to receive information for determining user location within an environment and determine the user location in relation to environmental characteristics of the location. An output module is configured to indicate user-location information with respect to said environmental characteristics and the electronic user-location device is configured to be worn by a user.

### CROSS-REFERENCE TO RELATED APPLICATIONS

This application claims the benefit of and priority to U.S. Provisional Patent Application Ser. No. 62/822,511, filed Mar. 22, 2019 and entitled “LOCATING ARRANGEMENT”, the entirety of which is incorporated herein by reference.

### TECHNICAL FIELD

The present invention relates to a locating device, in particular for use in relation to locating and maintaining connectivity to remotely located personnel.

### BACKGROUND

Movement within and through hazardous or remote environments is often required for an individual to perform their job. Therefore, the proper movement within and through these environments is essential for the safety of the individual as well as efficient job performance. The proper movement requires that the individual has access to location information and is in contact with rescue or remote personnel regardless of the conditions the individual is presented with within the environment. Since an individual's awareness of their location can become impaired as environmental conditions change, it is important for the individual to maintain their spatial awareness, both for their own safety and for the purposes of information exchanges with remote personnel.

In many instances, the individual may be equipped with a device that aids in the detection and monitoring of the individual as they move and work within the environment.

However, these devices suffer from limited connectivity (i.e., only capable of communication with one or a small number of other device) and the inability to obtain comprehensive location information. Furthermore, the current systems and devices are unable to effectively communicate the location information to and from the individual regardless of the conditions that exist within the environment and/or the condition of the individual.

These are just some of shortcomings that exist with current location devices and systems.

### SUMMARY

According to an embodiment, the locating device is an electronic user-location device. The electronic user-location device comprises an input module configured to receive data for determining a user location within an environment and is configured to determine the user location with respect to environmental characteristics of the location. An output module is configured to output the user location with respect to the environmental characteristics. The electronic user-location device is configured to be worn by the user. The electronic user-location device provides an accurate and reliable way to determine locational information relevant to the user, for use by the user and/or at a remote monitoring location device or control, and in a manner to compensate for environmental characteristics.

In an embodiment, the electronic user-location device is configured to provide the user locational data through the output module by way of a display device. The locational information can be output in a visual format, which may be further enhanced by augmented reality or virtual reality. However, the information to be output to the user may be in any appropriate format and including audio, tactile, and haptic signals either alone or in combinations thereof. In an embodiment, the output format may be automatically set based on the determined environmental characteristics. Since the user location will be most readily appreciated by the user through their visual awareness, unless impaired by environmental conditions, a visual presentation of the location information can prove particularly effective and user friendly. In an embodiment, the electronic user-location device is configured to be head-mountable and can comprise, for example, a pair of glasses, goggles or a visor.

For example, if it is determined that the environmental conditions exhibit a high volume of background noise, then visual and haptic indications may be provided rather than audio indications. Likewise, in situations where visual senses might be impaired, audio and haptic indications may be provided rather than visual indications. Further, when the environmental conditions exhibit extreme physical conditions such as temperature extremes or wind, visual and/or audio indications could be provided instead of haptic indications.

In an embodiment, the electronic user-location device may further include one or more sensors configured to detect additional environmental conditions that could aid in safety and/or locational determination. For example, the sensor may comprise a microphone configured to detect environmental noises and that may not be heard by the user due to other ambient noise. Visual, audio, or haptic indications may then be used to bring the environmental noises to the attention of the user.

In an embodiment, the environmental characteristics of a particular location are determined and adapted by the electronic user-location device to be presented visually to the user. Such visual presentation, preferably a way of augmented reality, may aid the user in identifying and verifying their location within the surrounding environment. The visual presentation may also provide directional information to the user in order to assist the user in finding safe passage to/from any particular location within the environment. Allowing for the safe movement of a user within the environment, or the safe passage of the user through the environment, is necessary to preserve the safety of the user and may also assist in collecting environmental data which may be processed and analyzed at a remote location.

In an embodiment, a remote monitoring device may further enhance the management and safe movement of the user within the environment independent of environmental conditions. The use of a remote monitoring device may also supplement the locational information that is presented to the user by the output module.

In an embodiment, the electronic user-location device includes one or more sensor modules configured to detect specific hazards such as heat sources, dangerous gas concentrations, and movement, such as moving mechanical parts. While the detection of such environmental characteristics may preserve the inherent safety of the user, the data collected may also be fed to a remote monitoring device for further processing and environmental analysis. An evolving understanding of factors pertaining to the local environment is created in this way, which leads to better identification of the severity of current and potentially future hazards within the local environment. If a plurality of users wearing electronic user-location devices are positioned within the environment, then the sensory data from all such users will enhance the detail and accuracy of the environmental analysis undertaken by the remote monitoring device. In an embodiment, the electronic user-location device may be configured for use in hazardous environments and may further be configured as an Intrinsically Safe wearable electronic device.

In an embodiment, the communication functionality of the electronic user-location device may enable communication of locational information to remote third parties so as to assist in the location of the user should the user become impaired or immobilized. This can greatly assist with the rescue of the user should it be required. The use of video as a means of data capture (whether or not in addition to the overlay and presentation of augmented reality) and the visual presentation of the location information are effective in determining the personal data/information of the user. Personal information concerning the well-being of the user, for example relating in particular to their medical condition, can then be available for example for ready communication to the emergency services.

Accordingly, the electronic user-location device enables the accurate and efficient self-management, or remote-management, of the movement and/or interaction of the user within their environment. The locational functionality exhibited by the electronic user-location device present may employ any appropriate form of geolocation data-processing. Characteristics of the environment such as those noted above may comprise, but are not limited to, any one or more of temperature, gas concentration, visibility, and physical obstacles whether stationary or in motion. The locational functionality of the invention may employ any appropriate geolocation functionality, and can employ standard GPS functionality, such as that supported by local wi-fi or Bluetooth communication. If the location of an injured user wearing the device needs to be broadcast to a first responder, then the electronic user-location device is configured to transmit location information to such first responders. The electronic user-location device further enables central monitoring of a user's progress and for communication with individual users.

In an embodiment, a method for determining the location of an individual within an environment and delivering data to the individual for determining their environmental location including determining the user's location with respect to environmental characteristics of the location is provided. The method comprises providing an output to the individual to indicate their location with respect to the environmental characteristics. The data delivered to the individual and output to the individual is delivered to, and output from the electronic user-location device.

The electronic user-location device is configured to provide an accurate and reliable means for determining locational information relevant to the user, for use by the user and/or by a remote monitoring device, and in a manner that can compensate for environmental characteristics. It should be appreciated that the method for determining the location of an individual within an environment may be further configured to utilize the various functions of the electronic user-location device discussed above. Accordingly, the ability of the user to wear the electronic user-location device enables the user to employ its functionality safely, possibly while on the move, and while allowing their hands to remain free. As such, the electronic user-location device may be used by the user as they are simultaneously engaged in other activities that might be inherent to the task being performed, or for example during an emergency situation requiring evacuation such as using a ladder, opening a hatch, carrying equipment, or casualty, or any other activity.

### BRIEF DESCRIPTION OF THE DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings in which:

FIG. 1 is a schematic depiction of an embodiment of an electronic user-location device positioned within a specific location with an environment; and

FIG. 2 is a schematic depiction of the of the electronic user-location device of FIG. 1 shown in greater detail.

### DETAILED DESCRIPTION

The following description relates to various embodiments of an improved locating system comprising an electronic user-location device. It will be readily apparent that these embodiments are merely examples and that numerous variations and modifications are possible that embody the inventive aspects discussed herein. Several terms are used throughout this description to describe the salient features of the invention in conjunction with the accompanying figures. These terms, which may include “first”, “second”, “inner”, “outer”, and the like are not intended to overly limit the scope of the invention, unless so specifically indicated. The terms “about” or “approximately” as used herein may refer to a range of 80%-125% of the claimed or disclosed value. With regard to the drawings, their purpose is to depict salient features of the locating system including a electronic user-location device and are not specifically provided to scale.

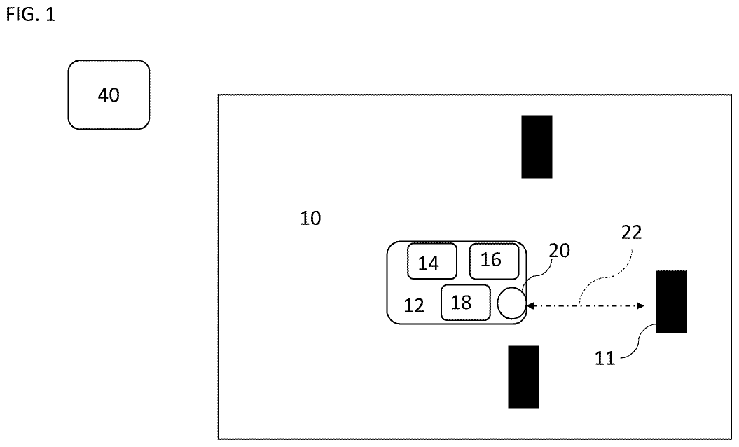

Turning first to FIG. 1, the electronic user-location device 12 is positioned within an environment 10. As shown, the electronic user-location device 12 may be worn by a user who is located in the environment 10 having one or more environmental characteristics or features 11. The features 11 may require the user wearing the electronic user-location device 12 to move with a degree of care and caution. Such features 11 can comprise physical obstacles, potential sources of gas/heat, potential dangers through the presence of moving parts, and specific entry and/or exit points.

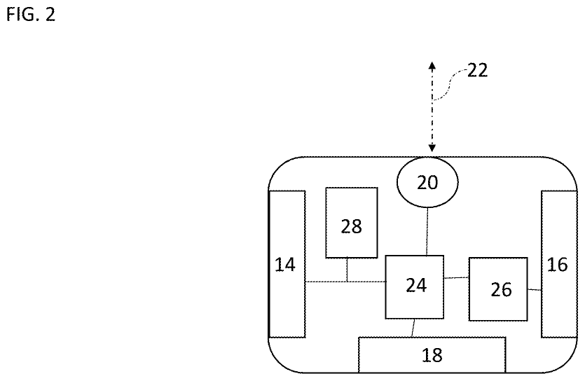

Referring to the embodiments illustrated in FIGS. 1 and 2, the electronic user-location device 12 generally comprises an input module 14 and an output module 16. The input module 14 is configured to receive data to assist in determining the location of the of the electronic user-location device 12 within the environment 10. The output module 16 is configured to output information to the user based on the data received by the input module 14. The output module 16 may output the information in any appropriate format such as visual, audio, and tactile/haptic. The output information may be locational information configured to keep the user apprised of his/her location and/or to be transmitted to a third party such as a rescue team, or remote monitoring device.

The electronic user-location device 12 may further include processing capabilities according to any known geolocation technique as is required for determining, indicating, and preferably displaying, the location of the user wearing the electronic user-location device 12 within the environment 10.

As shown in FIG. 1, the electronic user-location device 12 further includes one or more sensors 18 configured to obtain/determine parameters of the of the local environment 10. Such parameters may include, but are not limited to, heat sources, gas concentrations, pressure, and movement, particularly of machinery/equipment located within the environment 10. The electronic user-location device 12 may include a communication element 20 configured for bi-directional communication 22 with a remote entity outside of the environment 10, such as a remote monitoring device 40.

In an embodiment, the output module 16 comprises or is coupled to a display screen (not shown). In another embodiment, the output module is configured to display an image representing an augmented reality representation of the environment 10 within which the user is located. When the electronic user-location device 12 is capable of being worn on a user's head, the input module 14 is positioned such that it follows the user's line of sight. The determination of the user's location within the environment 10 and the associated generation of the augmented reality imagery by the output module 16 presents the user with a visual representation of the environment 10 as would appear in their line of sight, irrespective as to whether that portion of the environment 10 is actually visible at the time.

Therefore objects in the user's line of sight that may be obstructed or otherwise not visible to the user unaided due to poor environmental conditions or darkness are now visible to the user through the output module 16. The determination of the location of the electronic user-location device 12, and thus the user, within the environment 10 and the real-time display of the augmented reality version of the environment along the user's line of sight may aid the user's movement through the environment 10, especially in emergency situations. Accordingly, the user can recognize features of the local environment which may represent a danger to be avoided, such as a heat or gas sources or moving equipment. Alternatively, the user will be able to recognize features which may represent a target location to be accessed, such as an emergency exit.

The augmented reality representation of the environment 10 in association with the geolocation determination allows for self-determination by the user. Therefore the user will be apprised of the appropriate actions to take and the route to follow through the environment. In addition, the electronic user-location device 12 may be configured to communicate 20, 22 with a remote location control or remote location device 40 that is located outside the environment 10. If, for whatever reason, the user becomes immobilized due to problems within the environment 10 or injury, the locational data and its augmented reality representation can be transmitted 20, 22 to the remote location device in order to assist with rescue and/or on-site medical treatment of the user. When a plurality of such users with electronic user-location devices 12 are located within the environment 10, a greater appreciation of the total environment 10 can be developed with a more accurate determination of the location of potentially dangerous features. Moreover, the electronic user-location device 12 may also be configured to connect to safety equipment within the environment 10 or to at least identify the location and nature of such safety equipment within the environment 10.

Referring specifically to FIG. 2, the electronic user-location device 12 may include further processing capabilities 24, augmented reality display capabilities or processing 26, and memory or storage capabilities 28. The processing capabilities carried out by a processing element(s) 24 may include geolocation determination configured to determine the location of the electronic user-location device 12 within the environment 10 by way of signals received at the input module 14. As noted, the geolocation functionality can employ any appropriate form of geolocation determination such as standard GPS functionality, network-node-based or functionality, and that supported by wi-fi and/or Bluetooth connectivity. The determined location of the electronic user-location device 12 may then be transmitted 20 to the remote location device 40 for further processing as may be required, however the determined location may also be processed by the electronic user-location device 12 and displayed as part of an augmented reality representation of the local environment 10 by the output module 16.

The memory or storage capabilities (or memory) 28 may comprise, but are not limited to, volatile (e.g. random access memory (RAM)), non-volatile (e.g. read-only memory (ROM)), flash memory, or any combination or memory. An operating system and one or more programming modules may further be included as part of the memory capabilities. As shown, the memory 28 assists with operation of the processing element 24 and the augmented reality functionality or module 26. The memory 28 may further be configured to receive and store environmental data, such as map data relating to the known environment 10 and may be configured to assist with the determination and presentation of the location of the electronic user-location device 12. Of course, it should be appreciated that such processing to arrive at a determination of the user's location using augmented reality may be achieved at the remote location device 40 and communicated 20 back to the electronic user-location device 12.

The determination and display of the location of the electronic user-location device 12 and thus the user within the local environment 10 may be used to help locate the user, for example in an emergency situation, and for assisting with the guided movement of the user through the environment 10. In an embodiment, the electronic user-location device 12 is configured to be used within hazardous environments and may include an Intrinsically Safe wearable locating device. Accordingly, the electronic user-location device 12 may provide an enhanced means for the assistance and management of personnel within a hazardous area.

The electronic user-location device 12 may enhance the manner in which connectivity to remote workers within a particular manufacturing facility can be achieved and therefore, improve the overall safety and efficiency of the operation of the manufacturing facility. The electronic user-location device 12 may be use in distributed locations requiring a large number of operatives to carry out a wide variety of tasks and where specific Health and

Safety issues, and safe working practices might arise. The manner in which such a variety of requirements can be met is enhanced through use of the electronic user-location device 12 and particularly through the ability to track and monitor the movements/behavior of operatives within the field, and to maintain communication channels with them.

The electronic user-location device 12 may be uploaded with detailed map data relating to the particular local environment 10. In addition, the electronic user-location device 12 may be configured to connect with appropriate life support and safety systems within that environmental location. An application uploaded to the electronic user-location device 12 may be configured to track the location of the user and inform them by way of the output module 16 of any particular characteristics of the environment 10 or zone of the environment 10 they are in or about to enter. Guidance information may also be readily presented to the user to access particular equipment that might be found at specific locations in the environment 10.

In emergency situations, the electronic user-location device 12 may provide assistance to both an injured user and an emergency responder. For example, during an attempted evacuation of the environment during an emergency situation, the electronic user-location device 12 may provide a 3-D map of the local area and guide the user safely towards an exit in the most appropriate/efficient manner, irrespective of actual visibility. Of course, the electronic user-location device 12 is not limited to the visual presentation of information but, in addition, or as an alternative, may further provide audible instructions.

In another example, if the user becomes impaired, the emergency responder would be guided to the injured individual whose geolocation would be published by the electronic user-location device 12. The emergency responders could have a complimentary electronic user-location device 12 configured to guide them to the injured user and providing a communication link for ongoing discussions with the injured user should their condition allow. Video capabilities associated with the electronic user-location device 12 can further serve to relay visual information concerning any injuries to the user, or their general medical condition, for remote analysis by medical experts. Accordingly, the electronic user-location device 12 may comprise one or more cameras configured to capture still and/or moving images to be stored in the memory 28 and transmitted 20 to the remote location device 40, an emergency responder, and/or another user within the environment 10.

Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure.

What is claimed is:

1. An electronic user-location device comprising:
an input module configured to receive information for determining user location within an environment and determine the user location in relation to environmental characteristics of the location; and
an output module configured to indicate user-location information with respect to said environmental characteristics,
wherein the electronic user-location device is configured to be worn by a user.

2. The device according to claim 1, wherein the output module further comprises a display device configured to visually display the user-location information.

3. The device according to claim 2, wherein the display device is configured to display user-location information using augmented reality.

4. The device according to claim 2, wherein the visual display is configured to display user-location information using virtual reality.

5. The device according to claim 1, wherein the output module is configured to present the user-location information to the user in a format, wherein the format comprises at least one of a visual, an audio, a tactile, and a haptic format.

6. The device according to claim 5, further configured to enable the user to select the format that user-location information is presented.

7. The device according to claim 6, further configured to automatically select the format in which the user-location information is presented in response to environmental characteristics of the location.

8. The device according to claim 1, further comprising one of a pair of glasses, goggles, and a visor.

9. The device according to claim 1, wherein at least one of the input module and the output module is configured for wireless connectivity with a remote monitoring control and configured to transmit user-location to the remote monitoring control.

10. The device according to claim 9, further comprising one or more sensor modules configured to detect data pertaining to an environmental parameter, the environmental parameter comprising at least one of temperature, gas concentration, pressure, and motion, and wherein the data pertaining to the environmental parameter is transmitted from the at least one sensor module to the remote monitoring control.

11. The device according to claim 1, wherein the user-location is determined by geolocation.

12. The device according to claim 1, further configured to be used in hazardous environments.

13. The device according to claim 1, further comprised as an Intrinsically Safe device.

14. A method for determining a location of a user within an environment, the method comprising:
determining the location of the user with respect to characteristics of the environment; and
outputting to the user, the location of the user with respect to the characteristics,
wherein data delivered to the user and output to the individual is delivered to and output from a user wearable electronic device.

15. A method as recited in claim 14, wherein the location of the user is output using at least one of a visual, audio, tactile, and haptic format.
